(19) United States
(12) Patent Application Publication
(10) Pub. No.: US 2017/0036777 A1
(43) Pub. Date: Feb. 9, 2017

(54) TETHER SYSTEM FOR AERIAL VEHICLE

(71) Applicant: Qualcomm Incorporated, San Diego, CA (US)

(72) Inventors: Richard George Martin, San Diego, CA (US); Brad Lee Vaughn, Carlsbad, CA (US)

(21) Appl. No.: 14/816,926

(22) Filed: Aug. 3, 2015

(51) Int. Cl. B64F 1/12; B64C 39/02

(52) U.S. Cl. CPC B64F 1/12; B64C 39/022; B64C 2201/148

(57) ABSTRACT

According to some embodiments, there is provided a tether system for coupling an unmanned aerial vehicle (UAV) to an anchor location, the tether system comprising a tether line configured to couple the UAV to the anchor location during flight of the UAV, and an anti-entanglement (AE) member extending along a section of the tether line, the AE member having a first end proximate the UAV and a second end opposite the first end, proximate the anchor location.

### BACKGROUND

1. Field

Subject matter described herein relates generally to tether systems, and more particularly to various configurations of safety tether systems for coupling to aerial vehicles and, in particular, to unmanned aerial vehicles (UAVs).

2. Background

As unmanned aerial vehicles (UAVs) become increasingly popular for military, commercial, and recreational use, tethers for attaching to a UAV have been developed to decrease the risk of damaging or losing the UAV, and to mitigate the risk of injuring bystanders while the UAV is in flight. For example, beginner users of UAVs may not be adept at controlling the UAVs, and so the users may attach a tether to the UAVs while learning the controls. As another example, developers of UAVs may want to test out new innovations of a UAV, but effects on the flight of the UAV by the innovations may be unpredictable, and so a tether may be utilized to minimize risks involved with testing the UAVs. However, because tethers are physically attached to the UAV, the tether can render the UAV unstable by becoming entangled with the UAV (e.g., with propellers of the UAV), resulting in damage to the UAV.

### SUMMARY

In general, various embodiments relate to tether systems and methods of manufacturing tether systems for unmanned aerial vehicles (UAVs). A tether system according to some embodiments may minimize interference with the flight capabilities of an attached UAV, and may prevent the tether system from becoming entangled with the attached UAV.

According to various embodiments, there is provided a tether system for coupling an unmanned aerial vehicle (UAV) to an anchor location, the tether system including: a tether line configured to couple the UAV to the anchor location during flight of the UAV; and

an anti-entanglement (AE) member extending along a section of the tether line, the AE member having a first end proximate the UAV and a second end opposite the first end, proximate the anchor location.

In some embodiments, the tether system further includes a line reel configured to maintain a predetermined tension level of the tether line during flight of the UAV.

In some embodiments, the tether system further includes a connector coupled to the first end of the AE member, the connector configured to be removably attached to the UAV.

In some embodiments, the connector includes a rotation device configured to rotate 360 degrees along an axis of the tether line, the axis extending from the UAV to the anchor location.

In some embodiments, the tether system is configured to be coupled to the UAV at a surface of the UAV at a central location along a surface of the UAV.

In some embodiments, the tether system further includes a line weight attached to the second end of the AE member.

In some embodiments, the AE member is configured to flex corresponding to movement of the tether line as the tether line moves during flight of the UAV that is coupled to the tether line.

In some embodiments, the AE member includes a plurality of joints along its length, the AE member configured to flex at each of the plurality of joints corresponding to the movement of the tether line.

In some embodiments, the AE member is a portion of the tether line along the section that is heavier than a remainder of the tether line not at the section.

In some embodiments, the AE member includes a tubing surrounding the tether line at the section.

In some embodiments, the tubing is a spiral wrap surrounding the tether line at the section, the spiral wrap having a continuous angular slit along its length.

In some embodiments, at least a portion of an outer surface of the tubing is coated with an anti-friction coating.

In some embodiments, the tether system may further include a center ring, through which the tether line extends, arranged to be at a center of mass location of the UAV coupled to the tether line; and a plurality of suspension lines extending from the center ring, wherein each of the suspension lines is attached to a portion of the UAV.

In some embodiments, a number of the suspension lines equals a number of legs or arms of the UAV, and each suspension line is attached to a different respective leg or arm.

In some embodiments, the AE member extends through the center ring.

In some embodiments, the tether system may further include a center ring, through which the tether line extends, the tether line being attached to the center ring; and a plurality of suspension lines extending from the center ring, wherein each of the suspension lines is attached to a portion of the UAV.

According to various embodiments, there is provided a method of manufacturing a tether system for coupling an unmanned aerial vehicle (UAV) to an anchor location, the tether system including: providing a tether line configured to couple the UAV to the anchor location during flight of the UAV, and constructing an anti-entanglement (AE) member extending along a section of the tether line, the AE member having a first end proximate the UAV and a second end opposite the first end, proximate the anchor location.

In some embodiments, the method further includes connecting a line reel configured to maintain a predetermined tension level of the tether line during flight of the UAV.

In some embodiments, the method further includes coupling a connector to the first end of the AE member, the connector configured to be removably attached to the UAV.

In some embodiments, the method further includes coupling a line weight to the second end of the AE member.

### BRIEF DESCRIPTION OF THE DRAWINGS

FIG. 1A illustrates a perspective view of examples of an unmanned aerial vehicle and a tether system according to various embodiments.

FIG. 1B illustrates a side view of an example of a flight radius of an unmanned aerial vehicle according to various embodiments.

FIG. 1C illustrates a perspective view of an example of an unmanned aerial vehicle according to various embodiments.

FIG. 2 illustrates a perspective view of an example of a tether system attached to an unmanned aerial vehicle according to various embodiments.

FIG. 3 illustrates a perspective view of an example of an anti-entanglement member according to various embodiments.

FIG. 4 illustrates a side view of an example of a connector according to various embodiments.

FIG. 5 illustrates another example of a tether system attached to an unmanned aerial vehicle according to various embodiments.

FIG. 6 illustrates yet another example of a tether system attached to an unmanned aerial vehicle according to various embodiments.

FIG. 7 illustrates a method of manufacturing a tether system according to various embodiments.

### DETAILED DESCRIPTION

In general, various embodiments relate to apparatuses and methods of manufacturing and using tether systems for aerial vehicles and, in particular, unmanned aerial vehicles (UAVs). Various embodiments also relate to apparatuses and methods of manufacturing and using aerial vehicles with tether systems attached thereto. Various embodiments of tether systems are capable of reducing a risk of entanglement with attached UAVs.

The detailed description set forth below in connection with the appended drawings is intended as a description of various configurations and is not intended to represent the only configurations in which the concepts described herein may be practiced. The detailed description includes specific details for providing a thorough understanding of various concepts. However, it will be apparent to those skilled in the art that these concepts may be practiced without these specific details. In some instances, well-known structures and components are shown in block diagram form in order to avoid obscuring such concepts.

Various embodiments described herein can provide various benefits, including providing greater maneuverability for a UAV while a tether is attached thereto. Some embodiments described herein may mitigate the risk of an attached tether becoming entangled with the UAV during flight (e.g., during testing), or may provide a tether system with additional or improved performance capabilities and uses.

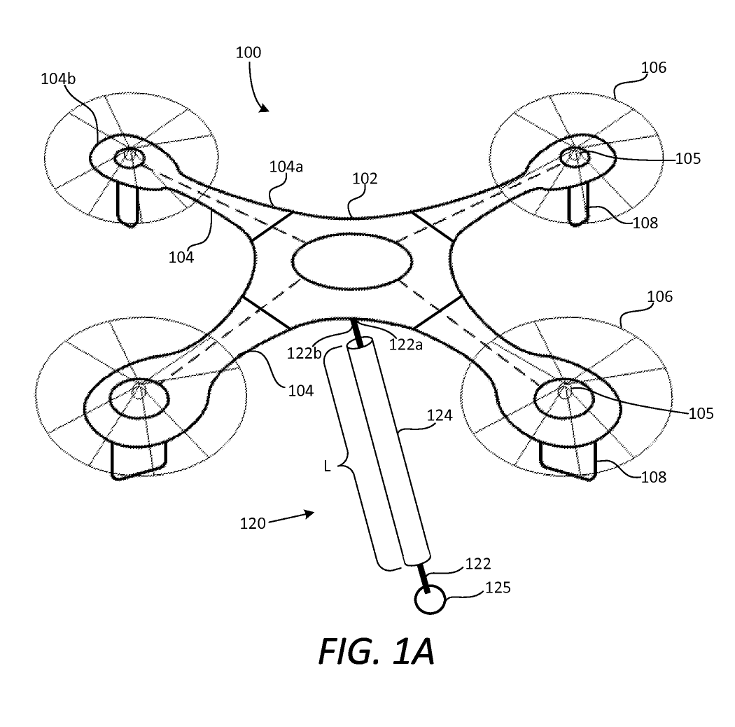

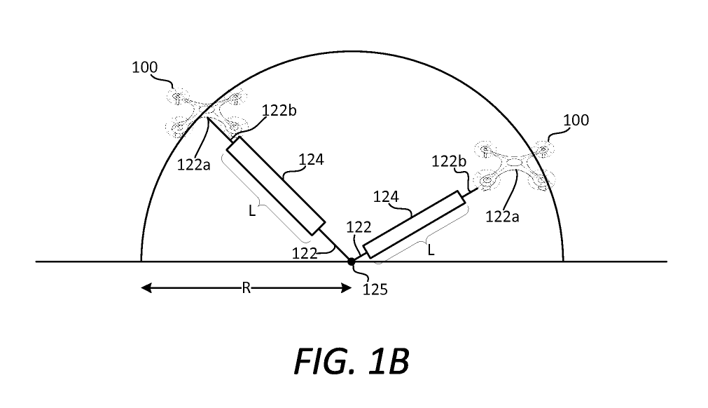

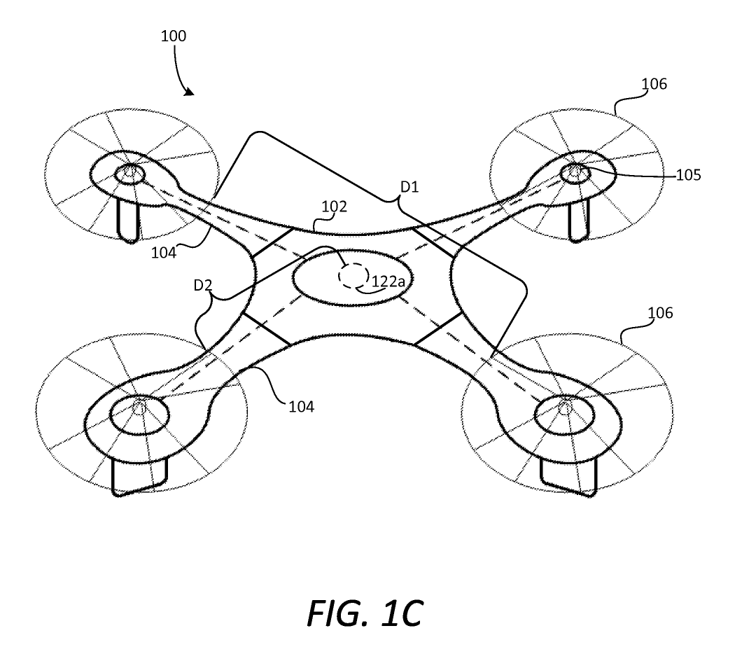

FIG. 1A illustrates a perspective view of examples of an unmanned aerial vehicle 100 and a tether system 120 coupled thereto according to various embodiments. Referring to FIG. 1A, the UAV 100 includes a main body 102. The UAV 100 further includes extended portions or “arms” 104 that extend from the main body 102. Each of the arms 104 has a first end 104a that is attached to the main body 102. Although some embodiments include four arms 104 extending from the main body 102, other embodiments of UAVs may include any suitable number of arms such as, but not limited to, one arm, two arms, three arms, or more than four arms. Other embodiments may include or employ a UAV having no arms, such as, but not limited to, a helicopter-style UAV having a propeller at its main body 102.

In some embodiments, the UAV 100 includes propellers 106 at a second end 104b of each arm 104, opposite the first arm end 104a. The propellers 106 are configured to provide aerial propulsion to the UAV 100 such that the UAV 100 is capable of flight and maneuvering during flight. The propellers 106 may be located on top of the arms 104, at the second ends 104b of the arms 104. In addition, the UAV 100 may have a plurality of legs 108, including a leg 108 at the bottom of each arm 104. The legs 108 support the UAV 100 in an upright or standing orientation, when the UAV 100 is on the ground and not in flight. In other embodiments, the propellers 106 may be provided at other suitable locations, such as, but not limited to, the end surface or the bottom of each of the arms 104. Each propeller 106 may be coupled to a respective motor 105. Each motor 105 may include a rotor. The motors 105 are configured to drive and spin the propellers 106 at speeds sufficient to achieve aerial propulsion of the UAV 100.

The main body 102 and the arms 104 of the UAV 100 may be made of any suitable materials, including, but not limited to, plastic, metal, wood, ceramic, composite material, or combinations thereof. In particular embodiments, at least a portion of (or the entire) structure of one or more (or each) arm 104 is composed of a circuit board material or substrate, on which one or more electrically conductive traces or other electrical circuit components are formed. In further embodiments, at least a portion of the main body 102 is composed of a circuit board material or substrate. Each motor 105 may be any suitable electrical motor that produces a rotational force to rotate a propeller 106, including, but not limited to, a DC electric rotary motor.

Although the UAV 100 may include propellers 106 in some embodiments, in other embodiments, the UAV 100 may include other suitable aerial propulsion systems to enable flight of a UAV, such as, but not limited to, a ducted fan system, a jet engine system, and/or the like. In other embodiments, UAV 100 may include any suitable number of propellers to enable flight of the UAV 100, including embodiments having two propellers or a single propeller. Although the UAV 100 includes a particular UAV configuration or style, other embodiments may include other UAV configurations, such as, but not limited to, helicopter-style UAVs, airplane-style UAVs (e.g., fixed-winged UAVs), zeppelin or blimp-style UAVs, and/or other multicopter-style UAVs, or combinations thereof. Also, while some embodiments are described herein with reference to UAVs, other embodiments may include or employ other types of aerial vehicles, such as, but not limited to, manned vehicles.

FIG. 1A illustrates a tether system 120 coupled to the UAV 100. The tether system 120 includes a tether line 122 that may be coupled at a coupling location 122a on the UAV 100 (or a component attached or otherwise coupled to the UAV 100). In some embodiments, the tether line 122 is configured to be coupled and decoupled from the UAV 100 in any suitable manner, such as, but not limited to, by tying, by a clip, by any other separate component configured to facilitate the coupling between the tether line 122 and the UAV 100 (e.g., a strap of material), and/or the like. In particular embodiments, the tether line 122 may be coupled at an underside of the UAV 100 at the coupling location 122a. The tether line 122 may be a flexible wire, light enough to minimize interference with the flight performance of the UAV 100 yet strong enough to not break under the stress and tension caused by the UAV 100 on the tether line 122 during flight. In some embodiments, the tether line 122 may include, but not be limited to, a string, a rope, a cable, a wire, a chain, or any other flexible length of material, such as, but not limited to, a solid single-strand metal wire or a multi-strand metal wire.

In some embodiments, the tether line 122 may be anchored or otherwise coupled to an anchor location 125. In various embodiments, the anchor location 125 may be located below the UAV 100 while the UAV 100 is in flight (e.g., on the ground), on a vertical surface to a side of the UAV 100 while the UAV 100 is in flight (e.g., at a wall), above the UAV 100 while the UAV 100 is in flight (e.g., on a ceiling), or at any other suitable anchoring location. In some embodiments, the anchor location 125 may include any suitable anchor for restricting a flight radius of the UAV 100, such as, but not limited to, a pedestal, a hook, a post, and/or the like. In various embodiments, the anchor location 125 may be located in an open area to allow 360-degree (or substantially near 360-degree) movement by the UAV 100. In some embodiments, the coupling location 122a on the UAV 100 may correspond to the type and/or location of the anchor location 125. In particular embodiments, the coupling location 122a may be arranged on the UAV 100 to face the anchor location 125 while the UAV 100 is in flight and orientated in a desired position (e.g., such that the UAV 100 flies in an upright position). For example, when the anchor location 125 is located at a ceiling (e.g., located above the UAV 100 while the UAV 100 is in flight), the coupling location 122a may be provided on a topside of the UAV 100.

FIG. 1B illustrates a side view of an example of a flight radius of the unmanned aerial vehicle 100 according to various embodiments. Referring to FIGS. 1A-1B, the tether line 122 coupled to the UAV 100 may have a length that corresponds to a radius R of a circle, the circle having a center that corresponds to the anchor location 125. As such, the tether line 122 may restrict movement of the UAV 100 to within an area of the circle having the radius R, such as a half circle as shown (e.g., in FIG. 1B). In other words, the tether line 122 may limit the UAV 100 from travelling beyond a circumference of a circle (e.g., when observing the UAV 100 from above as a top view) or a half-circle (e.g., when observing the UAV 100 from a side as a side view) having a radius R, the radius R corresponding to the length of the tether line 122. In other embodiments, the anchor location 125 may be located at a ceiling or a wall, and thus a maximum circumference of flight of a UAV 100 will correspond to a length of the anchored tether line 122, with the anchor location 125, which is at the ceiling or the wall, being at the center of the circumference of flight of the UAV 100.

In some embodiments, the tether line 122 may be or may include an electrically conductive wire capable of providing power and/or control signals to the UAV 100. In these embodiments, a first end of the tether line 122 may be coupled to a motor, a control module, or other electrical device at the UAV 100, and a second end opposite to the first end of the tether line 122 may be coupled to a power supply, an electrical switch, an electronic device, a user controller (e.g., a remote control for the UAV 100), and/or the like.

In various embodiments, the tether system 120 may also include an anti-entanglement (AE) member 124 extending along a section of the tether line 122. The tether line 122 may have an exposed portion 122b along which the AE member 124 does not extend. In some embodiments, the exposed portion 122b has a length that is less than (e.g., substantially less than) the length of the AE member 124. In particular embodiments, the AE member 124 is configured to surround the tether line 122, at the section of the tether line 122 along which the AE member 124 extends.

In some embodiments, the AE member 124 may be attached (or otherwise coupled) to the UAV 100 or may be attached (or otherwise coupled) to the tether line 122. For example, the AE member 124 may be attached to the UAV 100 or to the tether line 122 by adhesive, by welding, by tying via a separate strap of material, by friction fitting, or by any other suitable technique for maintaining the placement of the AE member 124 along the section of the tether line 122.

The AE member 124 may include (or be made of) a length of flexible material that may conform to the movement and bending of the tether line 122, as the UAV 100 maneuvers during flight. In some embodiments, the AE member 124 may have a sufficient mass that applies a weight to the section of the tether line 122 along which the AE member 124 extends to keep the tether line 120 directed downward and away from the UAV 100. In particular embodiments, the mass may be the mass of the AE member 124 itself or an additional weight that may be coupled to the AE member 124 to increase the overall weight of the AE member 124. According to some embodiments, the weight of the AE member 124 may be any suitable weight for maintaining the tether line 120 in the downward direction. Accordingly, the AE member 124, by adding weight to the tether line 122, and by physically encasing the tether line 122, may mitigate the risk of the tether line 122 contacting and becoming entangled with the UAV 100 during flight.

In some embodiments, the AE member 124 may be a hollow, straw-like tubing arranged along and surrounding a section of the tether line 122. In other embodiments, the AE member 124 may take on other suitable forms, such as, but not limited to, a tube with a “C”-cross section (i.e., the tube substantially surrounds the section of the tether line 122 and exposes a portion of the section of the tether line 122).

In some embodiments, the AE member 124 may have a plurality of locations along its length that are capable of flexing relative to each other to restrict substantial outward swinging (i.e., swinging significant enough to cause contact of the tether line 122 with the rotors or propellers 106 of the UAV 100 (or other portions of the UAV 100)). For example, the AE member 124 may include a structure having a plurality of rigid or semi-rigid sections connected end-to-end at flexible joints to form a structure with a plurality of joints along its length such that the AE member 124 can bend and conform to the shape of the tether line 122 as the UAV 100 maneuvers during flight. In some embodiments, the AE member 124 is a semi-rigid structure, such as, but not limited to, a rubber tubing, that allows for some flexible motion to minimize interference when landing, but is sufficiently rigid to restrict upward mobility of the tether line 122 during flight. As another example, the AE member 124 includes a spiral wrap tubing along a length of the tether line 122.

In other embodiments, the AE member 124 is not a separate component from the tether line 122, but is a section of the tether line 122 that is heavier (e.g., thicker, weightier, and/or coated), relative to the rest of the tether line 122 length. For example, the AE member 124 may take the form of chain links as a section of the tether line 122, and the remainder of the tether line 122 may be a lighter cable or wire. In other embodiments, the AE member 124 may be a rubber structure or other material that is different from the remainder of the tether line 122. In various embodiments, the characteristics or dimensions (e.g., thickness, composition, etc.) of the AE member 124 may be selected to decrease or increase the weight of the AE member 124.

FIG. 1C illustrates a perspective view of an example of the unmanned aerial vehicle 100 according to various embodiments. Referring to FIGS. 1A-1C, the AE member 124 may have a length L that is at least as long as, or about the same as, a length (distance) D1 between two farthest-spaced propellers of the UAV 100. For example, the length L of the AE member 124 may be about the distance D1 between a first propeller and a second propeller diagonally spaced across from the first propeller, along the diagonal dimension length of the UAV 100 and across the main body 102 of the UAV 100. Accordingly, in the event that the tether line 122 that is surrounded by the AE member 124 achieves a momentum large enough to cause the tether line 122 to contact the UAV 100, the tether line 122 itself would not contact the UAV 100, as the AE member 124 surrounding the tether line 122 may. In some embodiments, the length L of the AE member 124 may be a distance D2 from the coupling location 122a of the tether line 122 at the UAV 100 to a given propeller 106 (e.g., the closest propeller 106 to the coupling location 122a). In some embodiments, the length L of the AE member 124 may be from the coupling location 122a of the tether line 122 to a leg 108 or to an arm 104 (e.g., a closest leg 108 or arm 104) or to any other suitable part of the UAV 100. As such, in some embodiments, the length L of the AE member 124 may be directly proportional to a size of the UAV 100 (e.g., a diameter of the UAV 100, a distance between opposing propeller 106, etc.).

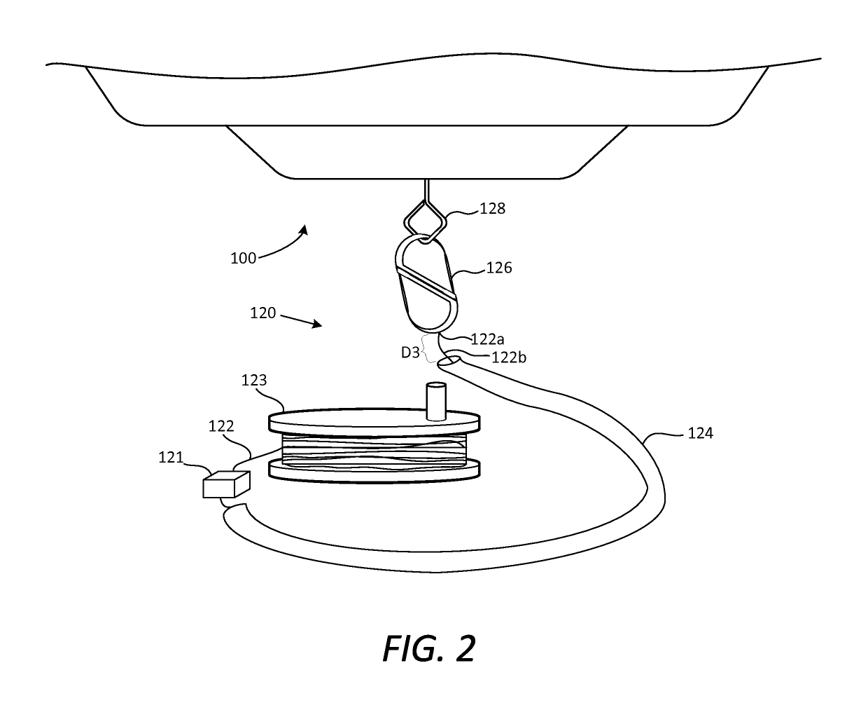

FIG. 2 illustrates a perspective view of an example of a tether system (e.g., 120 in FIG. 1A) attached to a UAV (e.g., 100 in FIG. 1A) according to various embodiments. Referring to FIGS. 1A-2, the tether system 120 may include a connector 126 attached to an end of the tether line 122 that is proximate to the UAV 100 (e.g., at coupling location 122a). In some embodiments, the tether line 122 is securely attached to the connector 126. In other embodiments, the tether line 122 may be coupled to the connector 126 by welding, by an adhesive, or by any other suitable technique for attaching the tether line 122 to the connector 126. The connector 126 facilitates attachment of the tether system 120 to the UAV 100. In some embodiments, the connector 126 may be an “S-clip” having a dual clipping system, with one clip of the S-clip being coupled to the tether line 122 and the other clip being coupled to the UAV 100. In other embodiments, the connector 126 may include other suitable mechanisms for attaching or otherwise coupling the tether line 122 with the UAV 100, such as, but not limited to, a single clip, a wire loop, a metal ring, or combinations thereof.

The UAV 100 may include an attachment member 128, which may correspond to the coupling location 122a, for connection with the tether system 120 via the connector 126. In some embodiments, the attachment member 128 may be located at an underside of the UAV 100 at a central location, such as a center of mass location of the UAV 100, so as to minimize disturbance of the flight trajectory of the UAV 100 as compared to flight when the tether system 120 is not attached. In other embodiments, the attachment member 128 may be provided on a topside of the UAV 100 or at a side of the UAV 100.

In some embodiments, the attachment member 128 may be a closed hook, and the first clip of the S-clip may be attached to the tether system 120 via the tether line 122, and the second clip of the S-clip opposite the first clip may be attached to the UAV 100 via the attachment member 128. In other embodiments, the first clip of the S-clip may be attached to the tether system 120 via the AE member 124. In some embodiments, the tether line 122 may be directly connected to the attachment member 128 (e.g., by being securely tied to the attachment member 128). In other embodiments, the AE member 124 may be attached directly to the UAV 100. For example, the AE member 124 may be directly attached to the attachment member 128 or to the connector 126 by any suitable technique for securing the AE member 124, such as, but not limited to, adhesive, a separate clip, a strap of material (e.g., a Velcro strap), or combinations thereof. In some embodiments, both the tether line 122 and the AE member 124 may be attached to the connector 126, or may be attached to the attachment member 128 (e.g., in embodiments that do not utilize the connector 126).

According to other embodiments, the distance of the AE member 124 from the UAV 100 along the tether line 122 may be a predetermined distance D3 (e.g., the distance between the end of the AE member 124 proximate the UAV 100 and the connector 126 may be a predetermined distance D3) that is selected to inhibit entanglement. In other words, according to some embodiments, there may be a predetermined length of exposed tether line 122b (e.g., not surrounded by the AE member 124). According to some embodiments, the distance D3 between the AE member 124 and the UAV 100 may be short enough to prevent the exposed tether line 122b from contacting the attached UAV 100 during flight of the UAV 100. In particular embodiments, the exposed tether line 122b may have a length less than the length or distance between the attachment member 128 and the leg 108 of the UAV 100.

According to some embodiments, the distance D3 between the AE member 124 and the UAV 100 (i.e., the length of the exposed tether line 122b) is relatively small. For example, in some embodiments, the length of the exposed tether line 122b between the AE member 124 and the UAV 100 (e.g., between the AE member 124 and the connector 126 or the attachment member 128) may be substantially less than the length L of the AE member 124, such that the distance D3, from the AE member 124 to the connector 126 along the tether line 122, is substantially less than the length L of the AE member 124.

According to various embodiments, the connector 126 may be any suitable connection device configured to be easily connected to and easily removed from the attachment member 128. In addition, according to some embodiments, the connector 126 may include a rotation mechanism or a swivel (not shown) configured to rotate relative to the UAV 100 to further mitigate entanglement of the tether line 122 during flight maneuvers of the UAV 100. For example, the connector 126 may be configured to rotate 360 degrees along its axis (e.g., along an axis extending from the coupling location 122a, between the tether line 122 and the connector 126, to the connection location between the connector 126 and the attachment member 128), along the axis of the AE member 124 (e.g., along an axis extending along the section of the tether line 122 surrounded by the AE member 124), or along the axis along the length of the tether line 122 extending from the UAV 100 (e.g., along the axis of the tether line 122 extending from the coupling location 122a to the anchor location 125).

In various embodiments, different suitable types of attachment members may be employed, such as, but not limited to, a strap, an adhesive, a plug, and/or the like. In accordance with these different attachment members, a corresponding connector 126 capable of engaging with the attachment member 128 may be used. For example, in some embodiments in which the UAV 100 includes a male plug attachment member 128, the connector 126 may be a corresponding female plug connector, or vice versa. According to some embodiments, the attachment member 128 may be any sturdy connection location for receiving a connection to the tether system 120, and for maintaining the connection to the tether system 120 during flight or throughout the duration of a flight session of the UAV 120.

In various embodiments, the tether system 120 may further include a line weight 121 at an opposite end of the AE member 124 from the end proximate the UAV 100. According to some embodiments, the line weight 121 has any suitable weight capable of further reducing entanglement of the tether line 122 with the UAV 100, without substantially interfering with the maneuverability of the UAV 100 during flight. In particular embodiments, the line weight 121 has any suitable weight such as, but not limited to, a weight of, or between, about 1 ounce or about 2 ounces. In some embodiments, the line weight 121 is a fastener such as, but not limited to, a square nut, a screw, a clasp, a rivet, a bolt, a washer, etc. In other embodiments, the line weight 121 includes a plurality of small weights (e.g., fasteners). In some embodiments, the line weight 121 may be implemented instead of, or in addition to, increasing the weight of the AE member 124 itself, and/or the line weight 121 may be implemented to increase the overall weight of the AE member 124 (by being attached thereto) for purposes of adding weight to the tether line 122 to mitigate the risk of the tether line 122 contacting and becoming entangled with the UAV 100 during flight.

In some embodiments, the line weight 121 may be attached to the AE member 124 at the opposite end of the AE member 124 from the end of the AE member 124 proximate the UAV 100. In particular embodiments, the line weight 121 is attached to the AE member 124 by welding, by adhesive, by a strap of material (e.g., Velcro), by being molded into the AE member 124 at the opposite end of the AE member 124 from the end proximate the UAV 100, or by any other suitable manner for securely attaching the line weight 121 to the AE member 124. In other embodiments, the line weight 121 is coupled to the tether line 122, such as, but not limited to, by being tied or strapped to the tether line 122, or by being molded into the tether line 122. In particular embodiments, the line weight 121 also serves to stop the AE member 124 from sliding down the tether line 124 when the AE member 124 is vertically oriented (e.g., during flight of the UAV 100).

In various embodiments, the tether system 120 may include a line reel 123 around which the tether line 122 is wound or spun. In some embodiments, the line reel 123 automatically maintains a predetermined amount of tension or slack in the tether line 122 regardless of the altitude of the UAV 100 during flight. The line reel 123 may be configured to detect a tension level of the tether line 122 at the line reel 123. The line reel 123 may release the tether line 122 or retract the tether line 122 based on the detected tension level. For example, if the tension of the tether line 122 is above a predetermined tension threshold, the line reel 123 may release more of the tether line 122, and if the tension of the tether line 122 is below a predetermined tension threshold, the line reel 123 may retract the tether line 123. In addition, the line reel 123 may be configured to restrict the length of the tether line 122 released from the line reel 123 such that the UAV 100, during flight, is limited to a radius R around the line reel 123 (e.g., as shown in FIG. 1B). As such, by maintaining tension in the tether line 122, and by minimizing excess slack of the tether line 122, the line reel 123 may further aid in mitigating risk of entanglement of the tether line 122 with the UAV 100. In other embodiments, the line reel 123 is manually operated by a user to maintain the tension or the slack.

In some embodiments, the line reel 123 (or an associated electronic device or sensor) is configured to monitor altitude magnitude of the distance of the UAV 100 from the surface to which the tether system 120 is anchored (e.g., the ground) during a flight session (e.g., by measuring the length of the released tether line 122 extended from the line reel 123). For example, in particular embodiments, the line reel 123 monitors the number of rotations (or partial rotations) of the line reel 123 and calculates the length of the released tether line 122 based on the determined number of rotations. In other embodiments, the tether line 122 has regular markings along its length, and the line reel 123 counts the markings to determine the amount of released tether line 122. In some embodiments, the line reel 123 is capable of measuring linear distance of the UAV 100 during a flight session by calculating the amount of tether line 122 released by the line reel 123.

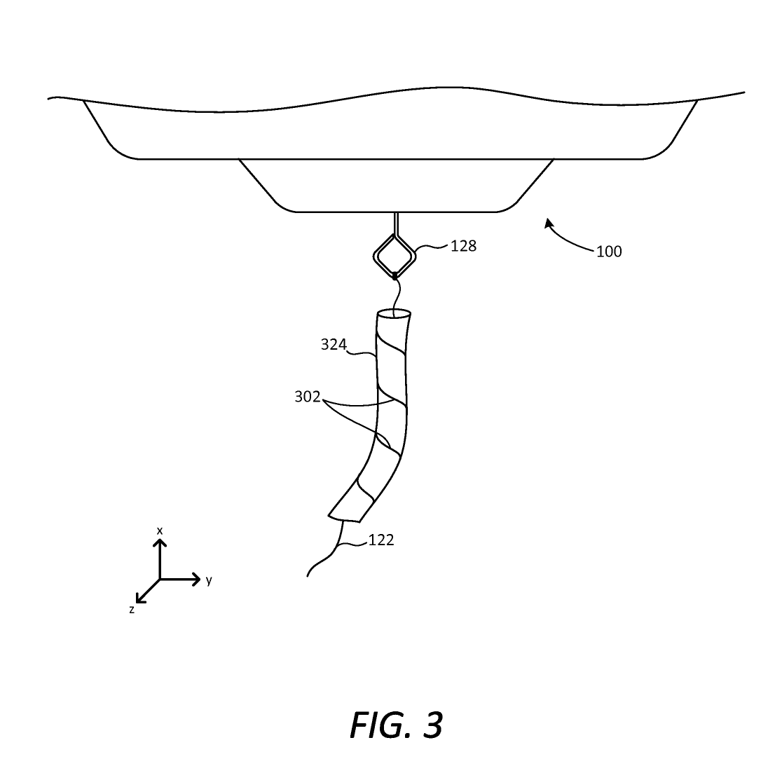

FIG. 3 illustrates a perspective view of an example of an anti-entanglement member 324 (which may correspond to the AE member 124 in FIGS. 1A-2) according to various embodiments. Referring to FIGS. 1A-3, the anti-entanglement member is a spiral wrap 324 wound around the tether line 122. As shown, an axis of the spiral wrap 324 along its length is referred to as the x-axis, with each of the y-axis and z-axis being perpendicular to the x-axis. According to some embodiments, the spiral wrap 324 has a continuous angular cut (or spiral slit) 302 along its length, which allows the spiral wrap 324 to flex along its length. For example, the spiral wrap 324 is capable of flexing corresponding to the trajectory of the tether line 122 (e.g., capable of flexing along the y-axis and the z-axis while extending along the x-axis), as the attached UAV 100 maneuvers during flight. At the same time, by encasing or surrounding the tether line 122, the spiral wrap 324 protects the tether line 122 from contacting the UAV 100 when the tether line would otherwise contact the UAV 100, reducing the risk of entanglement between the tether line 122 and the UAV 100. Accordingly, the spiral wrap 324 may absorb the energy of a swinging tether line 122, and may more quickly brings the tether line 122 to its default and balanced position (resting position) (e.g., extending directly downward from the UAV 100 along the x-axis).

According to some embodiments, the spiral wrap 324 may be made from one or more of a variety of materials for suitably enclosing the tether line 122 and adding weight to the tether line 122, to reduce risk of entanglement, while minimizing interference with the performance and flight maneuverability of the attached UAV 100. For example, the spiral wrap 324 may be made from any suitable plastic or polymer, such as, but not limited to, polyethylene, fire-resistant polyethylene, nylon, polytetrafluoroethylene, and UV-resistant polyethylene. In some embodiments, an outer surface of the spiral wrap 324 may be coated with a slick or slippery anti-friction or anti-abrasive coating to further prevent damage to, or entanglement with, the UAV 100, should the spiral wrap 324 come into contact with the UAV 100. According to some embodiments, the spiral wrap 324 is thick enough such that it tends to prevent entanglement or windings between the spiral wrap 324 and the UAV 100.

In some embodiments, the tether line 122 may be securely tied to the attachment member 128 itself (e.g., at a location corresponding to the coupling location 122a), without the use of a connector 126. In other embodiments, the tether line 122 may be attached directly to the UAV 100 (e.g., by adhesive, by nailing, by tying, etc.), without the use of a connector 126 or an attachment member 128. In particular embodiments, the tether line 122 may be coupled to the attachment member 128 or directly attached to the UAV 100 at a topside of the UAV 100, at an underside of the UAV 100, or at a side of the UAV 100. In further embodiments, the AE member 324 may be attached to the attachment member 128 or to the UAV 100 (e.g., by adhesive, by bolting, by tying, etc.) such that there is no exposed portion 122b of the tether line 122. According to some embodiments, the AE member 324 may be secured to the tether line 122 by any suitable techniques for securing the AE member 324 along a length of the tether line 122, such as, but not limited to, strapping, with a separate length of material, the AE member 324 to the tether line 122 at an end of the AE member 324, attaching the section of the tether line 122 surrounded by the AE member 324 to the interior of the AE member 324 (e.g., by adhesive, by welding, etc.), providing barriers at each end or at one end of the AE member 324 (e.g., at the end proximate the line reel 123) at the tether line 122 such that the AE member 324 is restricted from moving beyond those barriers (e.g., by fastening flat metal plates along the tether line 122 at each end of the AE member 324 such that the AE member 324 is contained between the plates), or combinations thereof.

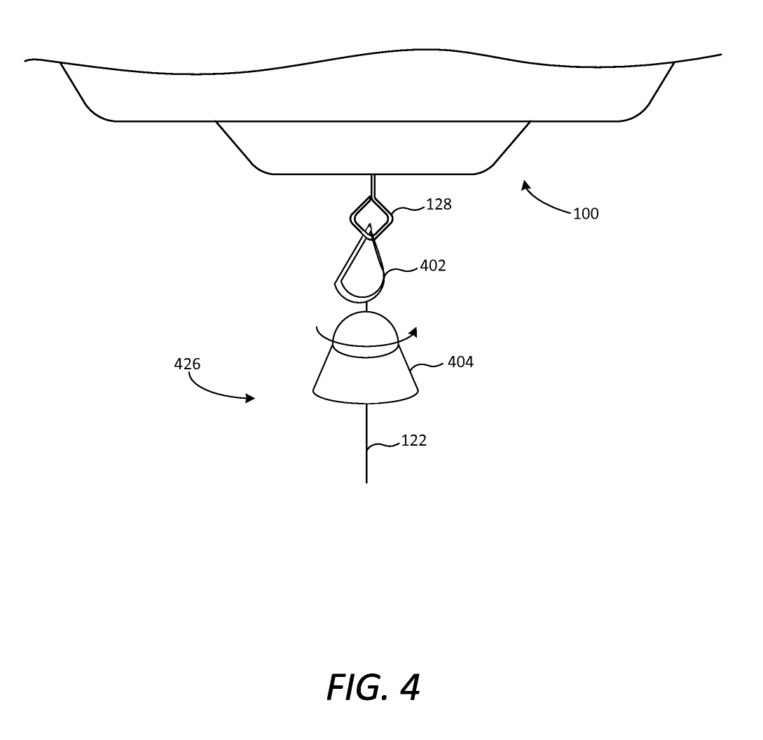

FIG. 4 illustrates a side view of an example of a connector 426 (which may correspond to the connector 126 in FIGS. 1A-3) according to various embodiments. Referring to FIGS. 1A-4, a tether system (e.g., 120) may include a connector 426 that is capable of rotating 360 degrees. As shown, a bottom of the connector 426 is coupled to the tether line 122, and a clip 402 is connected at the top of the connector 426 for removable connection to the attachment member 128 of the UAV 100, completing the connection between the connector 426 and the UAV 100. According to some embodiments, the connector 426 may be tied to the clip 402, welded to the clip 402, or otherwise suitably secured to the clip 402. In some embodiments, the connector 426 may include a rotation device 404 configured to rotate 360 degrees (e.g., along an axis of the tether line 122, with the axis being located along a direction extending from the UAV 100 to the anchor location 125). In some embodiments, the tether line 122 is permanently or removably secured to the rotation device 404 (e.g., by another clip, by adhesive, by welding, etc.). The rotation device 404 is coupled to the clip 402 that is coupled to the attachment member 128 of the UAV 100. Accordingly, the UAV 100 is capable of freely rotating and maneuvering during flight without the connector 426 or the tether line 122 hindering the rotation capabilities of the UAV 100 during flight.

In some embodiments, the rotation device 404 includes a ball and socket configuration. However, other embodiments may include different suitable rotation devices capable of achieving 360 degrees of rotation, such as a swivel connector. According to some embodiments, the attachment member 128 may be configured to rotate 360 degrees instead of, or in addition to, the connector 426.

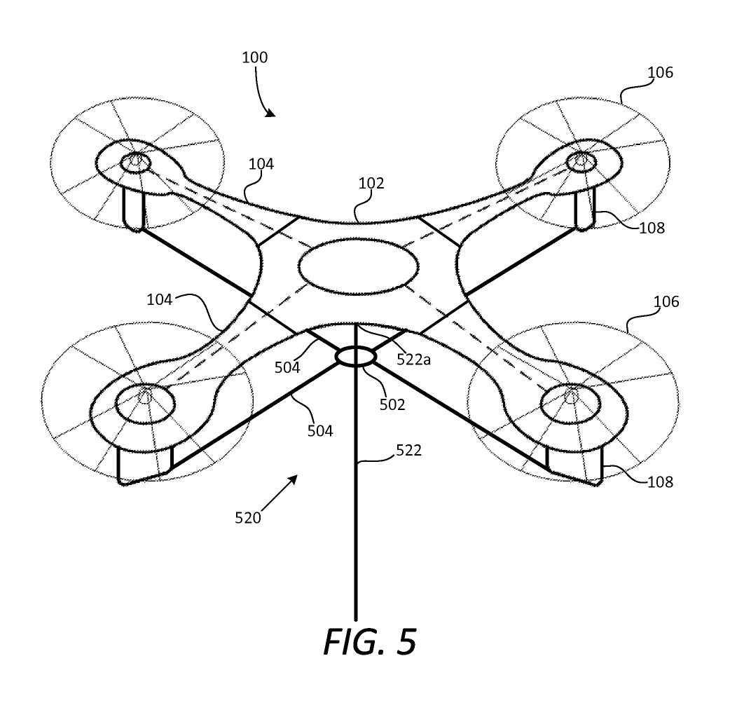

FIG. 5 illustrates an example of a tether system 520 (which may correspond to the tether system 120 in FIGS. 1A-4) according to various embodiments. Referring to FIGS. 1A-5, the tether system 520 includes a tether line 522 (which may correspond to the tether line 122 in FIGS. 1A-4) coupled to the UAV 100 at a coupling location 522a on the UAV 100 (or on a component attached or otherwise coupled to the UAV 100). In particular embodiments, the tether line 122 may be coupled at an underside of the UAV 100 at the coupling location 522a. In other embodiments, the coupling location 522a, at which the tether line 522 is coupled, may be located at a topside or at a side of the UAV 100. The tether line 522 may be removably attached to the UAV 100 in any suitable manner, such as, but not limited to, by tying, by a clip, by any other separate component configured to facilitate the coupling between the tether line 522 and the UAV 100 (e.g., a strap of material), and/or the like.

In some embodiments, the UAV 100 further includes a center ring 502 through which the tether line 522 extends. A plurality of suspension lines 504 may be attached to and extend from the center ring 502. According to some embodiments, the suspension lines 504 may be attached to the center ring 502 by welding, by adhesive, by being tied to the center ring 502, by being clipped to the center ring 502, or by any other suitable technique for securing the suspension lines 504 to the center ring 502. Each of the suspension lines 504 may be further attached to respective legs 108 of the UAV 100. In some embodiments, the suspension lines 504 may be secured to the legs 108 by tying, by welding, by adhesive, or by any other suitable technique for securing the suspension lines 504 to the legs 108. In other embodiments, the suspension lines 504 may be attached to respective arms 104 (or other suitable portions of the UAV 100). The suspension lines 504 serve to stabilize and to maintain the location of the center ring 502 at a position corresponding to where the tether line 522 is attached to the UAV 100 (e.g., at a central location of the UAV 100, such as a center of mass location of the UAV 100). As such, the center ring 502 is configured to substantially maintain a vertical orientation of the tether line 522 to help prevent entanglement between the tether line 522 and the UAV 100. In some embodiments, the tether line 522 may be attached at the center ring 502 (e.g., by welding, by tying, by clipping, etc.), instead of at the UAV 100.

Although some embodiments may include four suspension lines 504, any suitable number of suspension lines 504 may be used to maintain the position of the center ring 502 (e.g., two suspension lines). In particular embodiments, the number of suspension lines 504 may correspond to the number of arms 104, legs 108, or other members of the UAV 100. In other embodiments, the number of suspension lines 504 may be different from the number of arms 104, legs 108, or other members of the UAV 100. For example, for a UAV having a hexagon shape with six arms, there may be three suspension lines with a respective suspension line attached to, for example, alternating arms of the UAV.

According to some embodiments, the suspension lines 504 and the center ring 502 may be made from a rigid material (e.g., plastic, metal, rigid rods, reinforced polymers, metal composites, etc.) or an elastic material (e.g., rubber-like bands, etc.). In particular embodiments, the suspension lines 504 and the center ring 502 may be made from different materials or from the same material. In some embodiments, the center ring 502 is rigid while the suspension lines 504 are elastic. In other embodiments, the suspension lines 504 are rigid while the center ring 502 is elastic. According to some embodiments, the tether system 520 may further include the AE member 124 (or 324) along a portion of the tether line 522 that extends through the center ring 522. In other embodiments, the AE member 124 may be located along a length of the tether line 522 that begins below and extends downward from the center ring 502 (i.e., extends away from the UAV 100). In other words, according to some embodiments, a distance from the UAV 100 to the first end of the AE member 124 proximate the UAV 100 may be greater than a distance from the center ring 502 to the UAV 100.

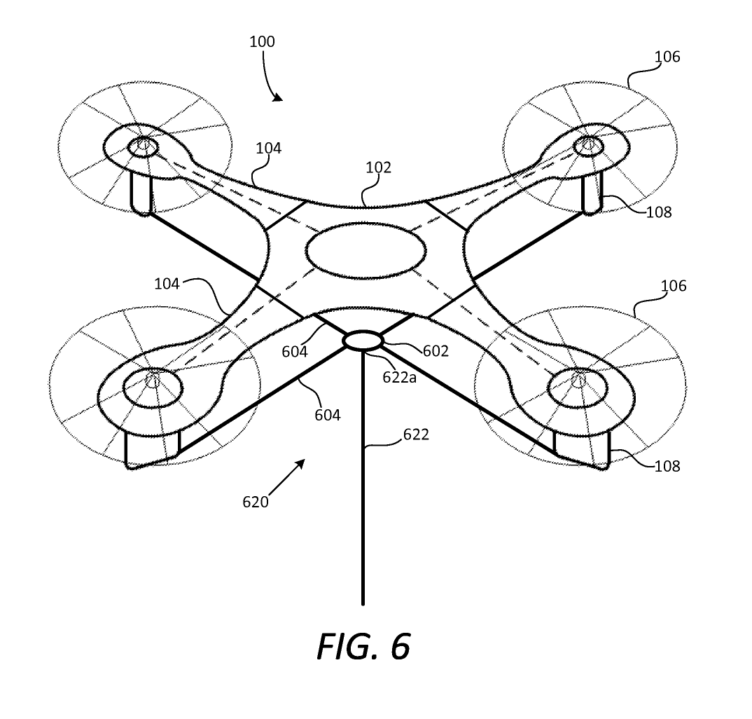

FIG. 6 illustrates an example of a tether system 620 (which may correspond to the tether system 120 in FIGS. 1A-4) according to various embodiments. Referring to FIGS. 1A-6, the tether system 620 may be coupled to the UAV 100 at a coupling location 622a on the UAV 100 (or on a component attached or otherwise coupled to the UAV 100). The tether system 620 includes a tether line 622 at an underside of the UAV 100, and a center ring 602 (which may correspond to the center ring 502 in FIG. 5) at which the tether line 622 may be attached (e.g., at coupling location 622a). The tether system 620 differs from the tether system 520 in that the tether line 622 is attached to the center ring 602, rather than extending through the center ring 502 to be attached to the UAV 100. The tether system 620 also includes suspension lines 604 (which may correspond to the suspension lines 504 in FIG. 5) extending from the center ring 602.

In other embodiments, the coupling location 622a, at which the tether line 622 is coupled to the center ring 602, may be located at a topside or at a side of the UAV 100. Furthermore, the tether line 622 may be removably attached to the center ring 602 in any suitable manner, such as, but not limited to, by tying, by a clip, by any other separate component configured to facilitate the coupling between the tether line 622 and the center ring 602 (e.g., a strap of material), and/or the like. In some embodiments, the center ring 602 may include a rigid or semi-rigid structure along the length of its diameter, for example, but not limited to, a metal or plastic rod. In some embodiments, the tether line 622 may be attached to the structure along the length of the diameter of the center ring 602, at the center of the center ring 602. As such, the tether line 622 may be attached at a center of mass point of the UAV 100.

According to some embodiments, the tether system 620 may further include the AE member 124 (or 324) along a portion of the tether line 622. The AE member 124 may be located along a length of the tether line 622 that begins below and extends downward from the center ring 602 (i.e., extends away from the UAV 100). The AE member 124 may be spaced from the coupling location 622a, between the tether line 622 and the center ring 602, such that there is a length of exposed tether line 622 immediately below the coupling location 622a.

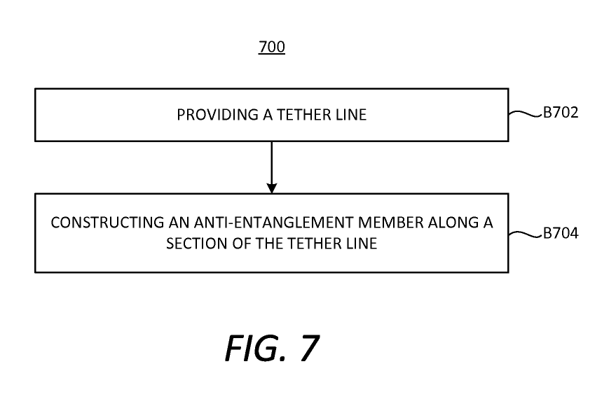

FIG. 7 illustrates a method 700 of manufacturing a tether system (e.g., 120, 520, or 620 in FIGS. 1A-6) according to various embodiments. Referring to FIGS. 1A-7, at block B702, the method 700 includes providing a tether line 122 for coupling to a UAV (e.g., 100). At block B704, the method 700 includes providing an anti-entanglement member 124 along a section of the tether line 122.

According to some embodiments, the method 700 may also include connecting a line reel 123 to the tether line. In some embodiments, the method 700 may include fastening a line weight 121 at an end of the AE member 124. In some embodiments, the method 700 may include attaching a connector 126 to the tether line 122 to couple the tether line 122 to the UAV 100.

The above used terms, including “attached,” “connected,” “fastened,” “secured,” “coupled,” “integrated,” and the like are used interchangeably. In addition, while certain embodiments have been described to include a first element as being “coupled” (or “attached,” “connected,” “fastened,” etc.) to a second element, the first element may be directly coupled to the second element or may be indirectly coupled to the second element via a third element.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout the previous description that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

It is understood that the specific order or hierarchy of steps in the processes disclosed is an example of illustrative approaches. Based upon design preferences, it is understood that the specific order or hierarchy of steps in the processes may be rearranged while remaining within the scope of the previous description. The accompanying method claims present elements of the various steps in a sample order, and are not meant to be limited to the specific order or hierarchy presented.

The previous description of the disclosed implementations is provided to enable any person skilled in the art to make or use the disclosed subject matter. Various modifications to these implementations will be readily apparent to those skilled in the art, and the generic principles defined herein may be applied to other implementations without departing from the spirit or scope of the previous description. Thus, the previous description is not intended to be limited to the implementations shown herein but is to be accorded the widest scope consistent with the principles and novel features disclosed herein.

What is claimed is:

1. A tether system for coupling an unmanned aerial vehicle (UAV) to an anchor location, the tether system comprising:
a tether line configured to couple the UAV to the anchor location during flight of the UAV; and
an anti-entanglement (AE) member extending along a section of the tether line, the AE member having a first end proximate the UAV and a second end opposite the first end, proximate the anchor location.

2. The tether system of claim 1, further comprising a line reel configured to maintain a predetermined tension level of the tether line during flight of the UAV.

3. The tether system of claim 1, further comprising a connector coupled to the first end of the AE member, the connector configured to be removably attached to the UAV.

4. The tether system of claim 3, wherein the connector comprises a rotation device configured to rotate 360 degrees along an axis of the tether line, the axis extending from the UAV to the anchor location.

5. The tether system of claim 1, wherein the tether system is configured to be coupled to the UAV at a surface of the UAV at a central location along the surface of the UAV.

6. The tether system of claim 1, further comprising a line weight attached to the second end of the AE member.

7. The tether system of claim 1, wherein the AE member is configured to flex corresponding to movement of the tether line as the tether line moves during flight of the UAV that is coupled to the tether line.

8. The tether system of claim 7, wherein the AE member comprises a plurality of joints along its length, the AE member configured to flex at each of the plurality of joints corresponding to the movement of the tether line.

9. The tether system of claim 1, wherein the AE member is a portion of the tether line along the section that is heavier than a remainder of the tether line not at the section.

10. The tether system of claim 1, wherein the AE member comprises a tubing surrounding the tether line at the section.

11. The tether system of claim 10, wherein the tubing is a spiral wrap surrounding the tether line at the section, the spiral wrap having a continuous angular slit along its length.

12. The tether system of claim 10, wherein at least a portion of an outer surface of the tubing is coated with an anti-friction coating.

13. The tether system of claim 1, further comprising:
a center ring, through which the tether line extends, arranged to be at a center of mass location of the UAV coupled to the tether line; and
a plurality of suspension lines extending from the center ring, wherein each of the suspension lines is attached to a portion of the UAV.

14. The tether system of claim 13,
wherein a number of the suspension lines equals a number of legs or arms of the UAV; and
wherein each of the suspension lines is attached to a different respective leg or arm.

15. The tether system of claim 13, wherein the AE member extends through the center ring.

16. The tether system of claim 1, further comprising:
a center ring, through which the tether line extends, the tether line being attached to the center ring; and
a plurality of suspension lines extending from the center ring, wherein each of the suspension lines is attached to a portion of the UAV.

17. A method of manufacturing a tether system for coupling an unmanned aerial vehicle (UAV) to an anchor location, the tether system comprising:
providing a tether line configured to couple the UAV to the anchor location during flight of the UAV; and
constructing an anti-entanglement (AE) member extending along a section of the tether line, the AE member having a first end proximate the UAV and a second end opposite the first end, proximate the anchor location.

18. The method of claim 17, further comprising connecting a line reel configured to maintain a predetermined tension level of the tether line during flight of the UAV.

19. The method of claim 17, further comprising coupling a connector to the first end of the AE member, the connector configured to be removably attached to the UAV.

20. The method of claim 17, further comprising coupling a line weight to the second end of the AE member.
